(19) United States
(12) Patent Application Publication
(10) Pub. No.: US 2012/0060996 A1
(43) Pub. Date: Mar. 15, 2012

(54) REINFORCEMENT LAYER MADE OF STEEL CORDS FOR BELTS OF PNEUMATIC VEHICLE TIRES

(75) Inventors: Viktor BLUEMEL, Hannover (DE); Wolfgang REESE, Peine (DE)

(73) Assignee: CONTINENTAL REIFEN DEUTSCHLAND GMBH, Hannover (DE)

(21) Appl. No.: 13/299,003

(22) Filed: Nov. 17, 2011

Related U.S. Application Data
(63) Continuation of application No. PCT/EP2009/065362, filed on Nov. 18, 2009.

(30) Foreign Application Priority Data
May 20, 2009 (DE) 102009025850.7

(51) Int. Cl. B60C 9/18; D02G 3/00; B29D 30/06

(52) U.S. Cl. 152/527; 156/117; 428/401

(57) ABSTRACT

Reinforcement layer for pneumatic vehicle tires that includes reinforcements formed by one of filaments or cords made of steel that are disposed substantially parallel to and spaced apart from one another and are embedded in rubber material. A cord is formed by a maximum of two filaments twisted together and all of the filaments of the reinforcements have a diameter of less than 0.24 mm and a maximum of two filaments are twisted in each case to form a cord.

### CROSS-REFERENCE TO RELATED APPLICATIONS

The present application is a Continuation of International Patent Application No. PCT/EP2009/065362 filed Nov. 18, 2009 and claims priority under 35 U.S.C. §119(a) of German Patent Application No. 10 2009 025 850.7 filed May 20, 2009, the disclosures of which being expressly incorporated by reference herein in their entireties.

### BACKGROUND OF THE INVENTION

1. Field of the Invention

The invention relates to a reinforcement layer for pneumatic vehicle tires. The reinforcements are steel filaments or steel cords, which are disposed substantially parallel to and spaced apart from one another within the reinforcement layer and are embedded in rubber material.

2. Discussion of Background Information

Steel filaments and steel cords as reinforcements in reinforcement layers for pneumatic vehicle tires are known. One example of an assembly of reinforcement layers is the breaker belt of a pneumatic vehicle tire. The bracing plies forming the belt assembly in pneumatic vehicle tires for cars are usually strengthened by steel cords as reinforcements. Many bracing plies that are nowadays incorporated in pneumatic car tires include steel cords of the construction 2×0.30 mm embedded in a rubber mixture and running parallel to one another. The 2×0.30 mm cord construction means that two filaments of 0.30 mm in diameter are twisted together to form a cord having a diameter of about 0.60 mm.

Sometimes, cord constructions in which the cord is surrounded by a spiral wrap are also used.

As discussed in the pending application, the term “filament” refers to a single wire, and the term “cord” refers to two or more filaments twisted together. Further, the term “spiral wrap” refers to a usually thinner wire which wraps around the cord in an opposing direction of lay.

Tire developments are constantly striving to achieve further reductions in the weight of the tire and further reductions in the rolling resistance of the tire.

### SUMMARY OF THE EMBODIMENTS

Embodiments of the invention provide a pneumatic vehicle tire for which the weight is further reduced and for which the rolling resistance is further reduced.

Accordingly, in embodiments, all the filaments in a reinforcement layer have a diameter of less than 0.24 mm and a maximum of two filaments being twisted in each case to form a cord.

Embodiments are directed to a reinforcement layer for pneumatic vehicle tires that includes reinforcements formed by one of filaments or cords made of steel that are disposed substantially parallel to and spaced apart from one another and are embedded in rubber material. A cord is formed by a maximum of two filaments twisted together and all of the filaments of the reinforcements have a diameter of less than 0.24 mm and a maximum of two filaments are twisted in each case to form a cord.

According to embodiments, the reinforcement layer can be formed as a breaker belt of pneumatic vehicle tire.

In accordance with embodiments of the instant invention, all the filaments of the reinforcements can have a diameter between 0.1 mm and 0.24 mm. All of the filaments of the reinforcements may have a diameter between 0.15 mm and 0.2 mm, and preferably each reinforcement can be a monofilament.

According to other embodiments, each reinforcement may contain at least one preformed filament.

In accordance with still other embodiments of the invention, the reinforcement may have a spiral wrap.

Embodiments of the present invention are directed to a pneumatic tire. The tire includes a breaker belt having a reinforcement layer and the reinforcement layer includes a plurality of reinforcements each comprising at least one filament having a diameter of less than 0.24 mm. The plurality of reinforcements are arranged substantially parallel to and spaced apart from each other and being embedded in rubber material.

In accordance with embodiments, each of the plurality of reinforcements can include one of a single filament and a cord formed by a maximum of two filaments.

According to other embodiments of the invention, each filament has a diameter between 0.1 mm and 0.24 mm, and preferably each filament may have a diameter between 0.15 mm and 0.2 mm.

Embodiments of the instant invention are directed to a method of forming a reinforcing layer of a pneumatic tire. The method includes embedding a plurality of parallelly aligned and spaced apart reinforcements in a rubber material. The reinforcements are formed by a maximum of two filaments, and each filament has a diameters of less than 0.24 mm.

According to embodiments of the invention, the reinforcements may be formed by one of a single filament and two twisted single filaments.

In accordance with still yet other embodiments of the present invention, each filament can have a diameter between 0.1 mm and 0.24 mm, and preferably a diameter between 0.15 mm and 0.2 mm.

### DETAILED DESCRIPTION OF THE EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

A reduction in the diameter of the reinforcements achieves the effect that a smaller volume of rubber is required for embedding the reinforcements within the reinforcement layer. In this manner, the rolling resistance of the tire is reduced. The reduction in the diameter of the reinforcements and the smaller volume of rubber also have the effect of making savings in the weight of the tire. In this way, the tire's rolling resistance is likewise reduced.

A cord construction of, for example, 2×0.22 mm has a cord diameter of about 0.44 mm. This reduced cord diameter has the effect that the reinforcement layer is thinner. Thus, a smaller volume of rubber is necessary for embedding the steel cords within this layer. If need be, the reduced strength of the reinforcement layer caused by using the reduced reinforcement diameters can be compensated by measures known to a person skilled in the art on the pneumatic vehicle tire.

The cords include or are made of steel. Steel of ultimate tensile strength classes NT, HT, ST or UHT may be used. By way of example, the following characteristics for a filament diameter of 0.20 mm can be obtained:
NT<3400 MPa
HT>=3400 MPa
ST>=3650 MPa
UHT>=4000 MPa.

In preferred embodiments, the filaments have a diameter of 0.1 mm-0.24 mm, and preferably a diameter of 0.175 mm.

It may be expedient for each reinforcement to be a monofilament comprising a single filament. As a result, the diameter of the reinforcement is again reduced, and so the volume of rubber necessary for the embedding in the layer is likewise again reduced.

In a particularly preferred embodiment, each reinforcement is a steel cord of the construction 2×0.175 mm.

The reinforcement layer according to the invention may be used in pneumatic car, van, light-truck and heavy-truck tires.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A reinforcement layer for pneumatic vehicle tires, comprising:
reinforcements formed by one of filaments or cords made of steel that are disposed substantially parallel to and spaced apart from one another and are embedded in rubber material;
wherein a cord is formed by a maximum of two filaments twisted together and all of the filaments of the reinforcements have a diameter of less than 0.24 mm and a maximum of two filaments are twisted in each case to form a cord.

2. The reinforcement layer as claimed in claim 1 being formed as a breaker belt of pneumatic vehicle tire.

3. The reinforcement layer as claimed in claim 1, wherein all the filaments of the reinforcements have a diameter between 0.1 mm and 0.24 mm.

4. The reinforcement layer as claimed in claim 3, wherein all of the filaments of the reinforcements have a diameter between 0.15 mm and 0.2 mm.

5. The reinforcement layer as claimed in claim 1, wherein each reinforcement is a monofilament.

6. The reinforcement layer as claimed in claim 1, wherein each reinforcement contains at least one preformed filament.

7. The reinforcement layer as claimed in claim 1, wherein the reinforcement has a spiral wrap.

8. A pneumatic tire comprising:
a breaker belt having a reinforcement layer;
the reinforcement layer includes a plurality of reinforcements each comprising at least one filament having a diameter of less than 0.24 mm, the plurality of reinforcements being arranged substantially parallel to and spaced apart from each other and being embedded in rubber material.

9. The pneumatic tire as claimed in claim 8, wherein each of the plurality of reinforcements comprise one of a single filament and a cord formed by a maximum of two filaments.

10. The reinforcement layer as claimed in claim 8, wherein each filament has a diameter between 0.1 mm and 0.24 mm.

11. The reinforcement layer as claimed in claim 10, wherein each filament has a diameter between 0.15 mm and 0.2 mm.

12. A method of forming a reinforcing layer of a pneumatic tire, comprising
embedding a plurality of parallelly aligned and spaced apart reinforcements in a rubber material,
wherein the reinforcements are formed by a maximum of two filaments, and each filament has a diameters of less than 0.24 mm.

13. The method as claimed in claim 12, wherein the reinforcements are formed by one of a single filament and two twisted single filaments.

14. The method as claimed in claim 12, wherein each filament has a diameter between 0.1 mm and 0.24 mm.

15. The method as claimed in claim 14, wherein each filament has a diameter between 0.15 mm and 0.2 mm.
